(19) United States
(12) Patent Application Publication
(10) Pub. No.: US 2007/0192706 A1
(43) Pub. Date: Aug. 16, 2007

(54) Service gateway for providing a scalable and loosely coupled service oriented architecture

(75) Inventors: Edwin J. Bruce, Corinth, TX (US); Romelia H. Flores, Keller, TX (US); Jason A. Salcido, Flower Mound, TX (US)

Correspondence Address: PATENTS ON DEMAND, P.A., 4581 WESTON ROAD, SUITE 345, WESTON, FL, 33331, US

(73) Assignee: INTERNATIONAL BUSINESS MACHINES CORPORATION, Armonk, NY (US)

(21) Appl. No.: 11/353,636

(22) Filed: Feb. 14, 2006

(51) Int. Cl. G06F 3/00; G06F 15/16

(52) U.S. Cl. 715/742; 705/52; 709/227

(57) ABSTRACT

The present invention utilizes a service gateway as a communication intermediary between clients and service providers. The gateway can include a dynamic runtime cache. Clients can communicate with the service gateway using a polling methodology. When polled information is already in the cache, the information can be immediately provided to the clients. Otherwise, the information can be obtained by querying a service provider. Service providers can communicate with the gateway using a subscription methodology. Information updates relating to subscriptions can be pushed to the cache. Hence, the cache always contains current information. Thus, clients are able to remain loosely-coupled in a service oriented architecture (SOA) without the SOA suffering from scalability or latency issues, which occur in conventional SOA implementations as the number of clients increase.

### BACKGROUND

1. Field of the Invention

The present invention relates to the field of service oriented computing and, more particularly, to an architecture for a scalable and loosely coupled service oriented architecture (SOA).

2. Description of the Related Art

Within any competitive market, businesses strive to distinguish their products and services from those of their competitors. One way to accomplish this is by positioning themselves within different markets of commerce favored by consumers. These markets can include store-front markets and mail-based markets, such as direct marketing by mail and catalogue based marketing. Markets can also include telephony markets and Internet-based markets, with Internet markets showing a strong increase in market share within recent years.

Customers increasingly expect to be able to interact with a business enterprise seamlessly across multiple markets using different interface channels. For example, a customer purchasing a book from a bookstore chain via a Web site (Internet interface channel) expects to be able to return the book at a local store (store-front interface channel). Similarly, a purchaser of an item from a department catalog (postal mail interface channel) expects to be to contact a service representative through a toll free phone number (telephone interface channel) to determine shipment status. In yet another example, bank customers expect to be able to monitor account activity and conduct transactions through automatic teller machines (kiosk or self-service channel) as well as through a bank's Web site (Internet interface channel).

Business enterprises have conventionally established different software systems for each of the various interface channels and/or for each of the various markets at which products or services are provided. That is, one software system can be designed for employee use at store fronts. A separate software system can be used by customer service representatives and interactive voice response systems that provide telephony based services to customers. Yet another software system can provide Web-based access to customers. Another software system can be used for employee payroll and for business expense accounting. Still, another software system can be used for enterprise logistics, item warehousing, and item procurement.

It can be difficult to construct interfaces between each of these varying systems of a business enterprise so that information within the systems is synchronized. A lack of synchronization, however, can result in a shortcoming in a customer's experience, as a customer's information from one channel is not available through another channel. In extreme cases, different store-fronts or outlets of the same interface channel, such as different retail outlets, will not have data synchronized with one another, so that a customer's interactions with one retail outlet are not available to the customer or service agent at a different retail outlet.

Problems with enterprise integration among various systems offering services through multiple channels is exasperated when one or more of the systems are updated or upgraded to be kept technologically current. Maintaining current software can be extremely important for back-end business systems, which are often based upon commercial software packages that are intermittently upgraded with new features. To successfully utilize desired features, often an entire software infrastructure will have to be upgraded. For example, a mail server, contact management system, and data base system can interoperate with one another so long as the versions of the various software systems are complementary. Upgrading one component may require the others to be upgraded, which may in turn require changes in the infrastructure of communicatively linked software systems.

It can also be extremely important for front end systems to be upgraded, especially in cases where users interface directly with the front end systems. For example, users of accessing a Web site of an enterprise via a browser may judge the competence of the enterprise in part upon the quality of the Web site. These users expect the latest innovations to be present, such as flash animation, windowing, speech processing technologies, multimodal access, and the like.

When considering all of the above factors, it is not surprising that enterprises spend enormous sums attempting to maintain, integrate, and update their software systems and to train their employees and customers to use these software systems. Many of these enterprises find that their expensive and tightly coupled software systems become outdated too quickly or is too inflexible to permit a new desired innovation to be implemented, without an infrastructure redesign, which is often cost prohibitive. Thus, even the best conventionally implemented enterprise software systems that initially provide a competitive advantage can provide to be a competitive liability in years to come.

Numerous companies have attempted to solve the above problems in various manners, one of which includes implementing a service-oriented architecture (SOA) within their information technology infrastructure. A SOA can provide a consistent, re-usable method for integrating any type of information consumer with any business process or information provider. In the SOA, a set of services can be defined that provide application functions. These services can serve as an abstraction layer that hides core system details from clients and provides a simple way to integrate consumers and service providers based upon standardized protocols, such as XML, WSDL, and SOAP.

Unfortunately, scalability problems and/or problems with maintaining a loose coupling between clients and service providers exist when implementing a SOA using conventional methodologies. These problems occur because an information receiving client typically desires to not only receive current data in response to a service request, but also desires to receive any information updates relating to that request.

A polling methodology between clients and service providers is often used to maintain a loose coupling in a SOA. Using a polling methodology, a client initially submits an information request to a service provider. The service provider can obtain the information needed for a response from a remotely located source and convey the obtained information within an information response to the client. Periodically, the information client can poll or query the service provider for updates. Each query can cause the service provider to query the information source and to provide an information response. Latency issues can arise between the clients and the information source due to this constant traffic that checks for data updates. This is particularly true when a distance between a client and a service provider and/or between a service provider and information source is relatively large or when bandwidth for conveying information between these entities is relatively low. Thus, a conventional polling SOA suffers from scalability issues as latency increases geometrically as a number of clients increase.

When latency issues are a predominant concern, a subscription methodology can be used to couple clients to an information source. In a subscription methodology, a client subscribes to a data context of an information source. Whenever the information source updates information, all subscriptions linked to the updated information are identified. The information source then pushes updates to subscribing clients. The subscription methodology creates a relatively strong coupling between clients and information sources, which often lessens the value provided by a SOA. For example, it is difficult to maintain a multi-channel architecture over many channels of commerce when clients are directly bound to a back-end information source via subscriptions.

### SUMMARY OF THE INVENTION

The present invention details a highly scalable service oriented architecture (SOA) that maintains a loose coupling between clients and service providers. More specifically, a service gateway can be used as a communication intermediary between clients and service providers. Clients can communicate with the service gateway via a polling methodology. One or more service gateways can be positioned so that latency between clients and the service gateways is relatively low.

Each service gateway can exchange information with a service provider via a subscription methodology. The service gateway can include an information cache in which data can be stored. The cache can be a dynamic runtime cache that includes data associated with the subscriptions between the service gateway and the service provider. Whenever subscription-related data is updated, a data update can be pushed from the information source to the dynamic runtime cache. Thus, information in the dynamic runtime cache can be kept current. Traffic and resultant latencies between the service gateway and the service provider can be minimal, since constant polling for updated information is unnecessary.

The present invention can be implemented in accordance with numerous aspects consistent with material presented herein. For example, one aspect of the present invention can include a service gateway. The service gateway can include a client portal and a provider portal. The client portal can receive service requests from clients and can responsively provide service responses to the received service requests. The client portal can exchange information with the clients using a polling methodology. The provider portal can forward service requests to service providers and can responsively receive service responses for the service requests. The provider portal can exchange information with service providers using a subscription methodology. The service provider can provide Web services. Communications between the clients and the service gateway and between the service gateway and the service providers can conform to a SOAP based protocol.

Another aspect of the present invention can include a scalable method for responding to service requests using a service gateway. In the method, a service gateway can receive one or more service requests from one or more clients. The service gateway can place answers to previous requests in a dynamic runtime cache. For each new service request, the dynamic runtime cache can be searched for an answer to the service request. When an answer is found in the cache, the answer can be directly conveyed to a client. When an answer is not found in the cache, the service request can be forwarded to a service provider. The service gateway can place an answer for the service request which was received from the service provider in the dynamic runtime cache. The answer can also be conveyed to a client that issued the service request.

Still another aspect of the present invention can include a service-oriented software system including at least one server provider and a service gateway. The service provider can include one or more service objects. Each service object can include a self-describing, self-contained, platform independent, modular unit of application logic. The service gateway can include a dynamic runtime cache in which information generated in response to service requests is stored. The service gateway can be configured to exchange information with the service provider using a subscription based methodology. Clients can submit requests and can receive information from the service gateway using a polling based methodology.

It should be noted that various aspects of the invention can be implemented as a program for controlling computing equipment to implement the functions described herein, or a program for enabling computing equipment to perform processes corresponding to the steps disclosed herein. This program may be provided by storing the program in a magnetic disk, an optical disk, a semiconductor memory, or any other recording medium. The program can also be provided as a digitally encoded signal conveyed via a carrier wave. The described program can be a single program or can be implemented as multiple subprograms, each of which interact within a single computing device or interact in a distributed fashion across a network space.

### BRIEF DESCRIPTION OF THE DRAWINGS

There are shown in the drawings, embodiments which are presently preferred, it being understood, however, that the invention is not limited to the precise arrangements and instrumentalities shown.

FIG. 1 is a schematic diagram of a system that illustrates a scalable service oriented architecture (SOA) in accordance with an embodiment of the inventive arrangements disclosed herein.

FIG. 2 can be a schematic diagram of a system of a SOA designed so multiple clients can access enterprise information through several different channels of commerce.

FIG. 3 is a schematic diagram of a system where clients interact with a service gateway using a polling methodology and where the service gateway interacts with service providers using a subscription methodology in accordance with an embodiment of the inventive arrangements disclosed herein.

### DETAILED DESCRIPTION OF THE INVENTION

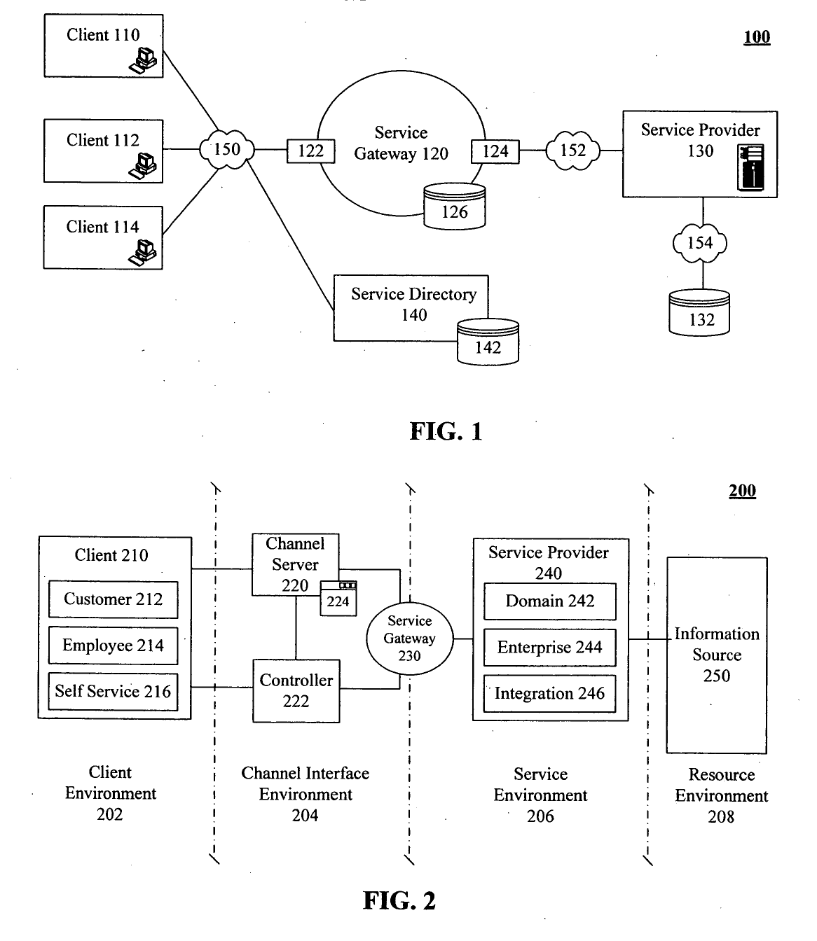

FIG. 1 is a schematic diagram of a system 100 that illustrates a scalable service oriented architecture (SOA) in accordance with an embodiment of the inventive arrangements disclosed herein. The method and apparatus described in system 100 specify a unique architecture that combines the simple, loosely-coupled advantages of SOA based systems with more traditional methods of integration to create a unique solution for accessing information in a SOA fashion. More specifically, the invention integrates a client-side polling methodology with a provider-side subscription methodology. Thus, the invention utilizes find/bind/invoke operations found in many SOA implementations and enables clients to obtain updates to information without incurring scalability issues as the number of clients increase.

System 100 can include client 110, client 112, and client 114 which convey service requests to service gateway 120 over network 150 and receive responses to these requests. The responses can be generated from previously obtained information stored in cache 126 or can be responses obtained from the service provider 130 specifically for the client submitted request.

Each of the clients 110-114 can include a computing device having installed software though which users can obtain information. The computing devices upon which the clients 110-114 reside can include a server, desktop computer, a laptop, a tablet computer, a customer kiosk, a Web browsing device, a personal data assistant (PDA), a mobile phone, a media player, and other such devices.

Different types of clients 110-114 having different purposes and can be used by different categories of users. For example, when clients 110-114 are used to access business information, each of the clients 110-114 can represent an employee computing station, a customer access portal, or self-service stations. Each of the different categories of clients can include a different user interface specifically tailored for a particular channel of commerce. Additional channel specific servers (not shown) can convert channel or interface independent service responses into channel or interface specific responses, as necessary. Clients 110-114 can query service directory 140 via network 150 to find a desired service provider 130, which is capable of answering an information query to perform a desired task.

The service directory 140 can be an online directory that provides a uniform way for businesses and organizations to describe available services, service capability, required interface parameters, and output parameters resulting from the described services. In one embodiment, the service directory 140 can use an eXtensible Markup Language (XML) based directory of Web services. Web services specified in the service directory 140 can be described using a Web services description language (WSDL). The service directory 140 can be a universal description discovery and integration (UDDI) directory.

Service provider 130 can be any provider of a service advertised in the service directory 140. Service providers 130 can be implemented as components (e.g. ENTERPRISE JAVA BEAN (EJB) components) that run on an application server. Many different types of service providers 130 can exist, each of which provides a particular type of service. Service provider 130 can include, for example, a security service provider that provides client authorization, such as user identity information, user authorization information, and other security parameters. System provider 130 can also be an information service provider that permits clients 110-114 to use service requests to selectively obtain information from information data store 132 via network 154. Service provider 130 can also include an integration service provider that functions as an integration point or architecture hub that spans disparate systems or service providers in an enterprise.

The information and security service providers can be components that primarily implement the process of mapping SOAP based requests from clients 110-114 to back-end information providing systems. An information service provider can have an additional responsibility for maintaining a subscription database (not shown) as well as an information repository 132.

The service gateway 120 can be a communication intermediary between clients 110-114 and service provider 130 communicatively linked to each via network 150 and network 152. The service gateway 120 can exchange information using XML-based messages. The service gateway 120 can include a client portal 122 that can receive service requests from clients 110-114. Service responses can be provided to requesting clients 110-114.

Client 110-114 communications with the service gateway 120 via the client portal 122 can be based upon a polling methodology. That is, each time the client 110-114 requires data, a request can be generated by the client 112 and routed through service gateway 120. The gateway 120 can use the cache 126 to first determination if previously stored information exists, which can satisfy the request. If so, an appropriate SOAP response for the request can be immediately returned. Otherwise, service gateway 120 can retrieve the requested information from the service provider 130.

Notably, a SOA arrangement including service gateway 120 can reduce latency by not requiring a request flow to be conveyed to the service provider 130 and back. It can also increase scalability by ensuring that the service provider 130 does not have to answer every request.

The service gateway 120 can include a provider portal 124 configured to forward service requests to service provider 130. The provider portal 124 can receive service responses for the forwarded service requests. The service gateway 120 can place information from the responses in cache 126 and can also convey service response information to requesting clients 110-114.

Communications between service gateway 120 and service provider 130 via the provider portal 124 can be based upon a subscription methodology. That is, an information source can update information data store 132, and can also inform the service provider 130 of the update. Upon being informed, the service provider 130 can then determine which existing subscriptions are affected by the event. Once the service provider 130 has determined affected subscriptions, data context updates for each subscription can be proactively generated. Data updates can be published to all subscribers.

Cache 126 can be a dynamic runtime cache in which responses to service requests are stored. Service responses contained in the cache 126 can be decomposed into component parts or subtopics to facilitate re-use. These sub-topics can be rebuilt by the service gateway 120 to respond to service requests. The data contained in the cache 126 can be bound to an information source. The binding permits the information to be pro-actively updated before client requests for the updated information is received.

Clients 110-114 which use a polling methodology, must still query the service gateway 120 for updates. Since the cache 126 is automatically updated, current data can be immediately retrieved for the update queries and sent to the clients 110-114. Thus, less traffic is conveyed between the clients 110-114 and service provider 130 than would be conveyed with a conventional SOA.

In one embodiment, service gateway 120 can be implemented using middleware that assists with the interception, routing, and transformation of XML-based messages. The exact protocol used by the service gateway 120 can depend upon client 110-114 configurations. The publishing aspects for pushing data to the service gateway 120 can be implemented using a variety of commercial messages oriented middleware solutions, such as a MQSERIES package.

The service gateway 120 can be an extremely lightweight component that does not necessarily include business logic. Instead, the service gateway 120 can include logic for rudimentary message routing/transformation operations. Thus, for a relatively low cost, many gateways 120 can be implemented that can be physically located close to clients 110-114. Overall processing power required to handle requests in a SOA that uses at least one gateway 120 can be less than the processing power required for an information service provider 130 to handle the requests. The number of gateways 120 can be easily increased to handle greater volumes of traffic.

Networks 150, 152, and 154 can include any hardware/software/and firmware necessary to convey data encoded within carrier waves. Data can be contained within analog or digital signals and conveyed though data or voice channels. Networks 150, 152, and 154 can include local components and data pathways necessary for communications to be exchanged among computing device components and between integrated device components and peripheral devices. Networks 150, 152, and 154 can also include network equipment, such as routers, data lines, hubs, and intermediary servers which together form a data network, such as the Internet. Networks can also include circuit-based communication components and mobile communication components, such as telephony switches, modems, cellular communication towers, and the like. Each of the networks 150, 152, and 154 can include line based and/or wireless communication pathways.

Data stores 126, 132, and 142 can each be a physical or virtual storage space configured to store digital information. Each of data stores 126, 132, and 142 can be physically implemented within any type of hardware including, but not limited to, a magnetic disk, an optical disk, a semiconductor memory, a digitally encoded plastic memory, a holographic memory, or any other recording medium. Each of data stores 126, 132, and 142 can be a stand-alone storage unit as well as a storage unit formed from a plurality of physical devices. Additionally, information can be stored within data stores 126, 132, and 142 in a variety of manners. For example, information can be stored within a database structure or can be stored within one or more files of a file storage system, where each file may or may not be indexed for information searching purposes. Further, data stores 126, 132, and 142 can utilize one or more encryption mechanisms to protect stored information from unauthorized access.

FIG. 2 can be a schematic diagram of a system 200 of a SOA designed so multiple clients can access enterprise information through several different channels of commerce. System 200 can represent one potential embodiment where the components of system 100 can be integrated to ensure a scalable system where clients remain loosely coupled to an information source. Accordingly, each client 210 can represent one instance of a client 110-114. Notably, client 210 interacts with service gateway 230 via a polling methodology, while the service gateway 230 interacts with service provider 240 via a subscription methodology.

Referring to FIG. 2, an integrated set of logical component in a system 200 can be assembled together to solve a multi-channel integration problem using a scalable SOA. Clients 210 (in a client environment 202) in each channel (using a channel server 220 or a controller 222 in a channel interface environment 204) can be divided into three types: customer 212, employee 214, and self-service 216.

The customer and self-service clients (212 and 216 respectively) can both be used by enterprise customers via the channel interface environment 204. The self-service client 216 is one that can have additional constraints on its use and, therefore, can require a controller 222 that provides access to an enterprise service provider 244 and a related system or record or service server 250. An employee client 214 can be used by employees in the channel 220. In all cases, some variety of components 224 drives the user experience for these user devices.

The component 224 can be highly dependant on the channel requirements. Integrated into this experience are business applications that actors in each channel will use to perform business functions or access information. Each of these applications can also be highly dependent on the channel. In any event, embodiments herein have widely varying applications that are integrated to core systems, such as core business systems. The integration is done in a manner that is distinguishable from other traditional methods of integration.

The service gateway 230 provides enterprise service access to channel applications executing on client 210. The service gateway 230 can be responsible for accepting SOAP formatted XML requests from local application servers (220). It then can discover the appropriate service provider 240 and can pass the request to the provider, adding any additional meta-data into the XML Request. These transformations are usually common activities that all service requests must have performed before they are received by service provider. The gateway 230 can serve as a central component that performs these functions reducing the burdens of the channel client or application. The gateway 230 may bind to the provider dynamically or through well-defined communication channels. The service gateway 230 can also store bound provider data within a dynamic runtime cache. The gateway 230 can directly respond to client 210 request using data stored in the dynamic runtime cache. Provider 240 can receive data updates from information source 250, which it can propagate to bound data elements, such as those within the dynamic runtime cache.

Accordingly, the gateway 230 can cache results initially obtained from service provider 240, which in turn can be obtained from information source 250. That is, in the event of an unknown service request, the gateway 230 can request a binding location from an integration service hub 246. The integration hub 246 can be a system of record for all valid service requests. Once found, the request will be passed to the appropriate endpoint. The gateway 230 can store the location of the provider and bind directly on subsequent requests.

The level of availability for the service gateway 230 can depend on the desired implementation. In one embodiment, multiple service gateways 230 can be implemented using several application servers that be clustered together to provide one seamless gateway. In another embodiment, different independent service gateways 230 can exist, each receiving requests from different clients.

With respect to the design rationale of such a system, using a services gateway 230 involves looking at the enterprise from a functional or “service” point of view. By organizing the enterprise into a service-oriented architecture, a client 210 may interact with enterprise servers (250) through an abstracted interface (204), which is defined in an XML language. The main advantage to such an approach is simplification of the method of integration between applications and their enterprise resources. Defining XML interfaces abstracts the service, hiding implementation details and complexities from the client 210. A service provider 240 is responsible for interpreting a service request, accessing the enterprise system(s) to perform the service function and returning a proper service response, if required. The service gateway 230 serves as a central point for access to services across the enterprise.

In order to implement the service gateway 230, two activities must be completed. First, the business requirements for local processing and performance must be defined. This will determine what kind of footprint the gateway 230 will have and what functionality can be provided. Account of all the non-functional requirements like performance and availability as well as the type of application support required should be considered. For instance, the level and type of security required will depend on the business and legal requirements. There can also be some analysis of the required legacy systems for branch activities. However, because the intention will be to “hide” these systems behind service providers 240, the impact of these systems on the overall design can be minimal.

Second, the functional aspects of the enterprise can be organized into services that are consumed by the branch components. This service-oriented approach allows for a more vendor-independent implementation because the component interactions are defined in platform-independent XML. This will also eliminate some implementation decisions that are forced by vendor technologies. Service providers 240 can be built to translate the request to vendor-specific actions in legacy systems.

The interactions between branch components and the enterprise must then be defined using standard design methodologies. When defining service abstractions, it is important to remember that these services will be shared by many different components. The method for describing these interactions should be based on industry standards in order to minimize risk. Using a W3C standard such as SOAP for the overall XML payload description will increase the amount of vendor product choices and support.

Once these activities have been completed, a selection of vendor products to support the development and deployment of a gateway can be made. There will be a certain amount of programming required to handle the service requests such that the business requirements are satisfied. Depending on the level of application support required, a variety of components might be used.

Once the gateway 230 has performed the necessary transformations for a service request, it is routed to a service provider 240. Service providers 240 are the instantiation of a service-oriented architecture. They are used to enable access to enterprise systems 250 and functions using standardized SOAP XML messages over a common network protocol. Using this approach minimizes the amount of work and infrastructure required to integrate channel clients and application servers with centralized resources. A service provider 240 is responsible for accepting SOAP formatted XML requests from any application source. The network protocol used will vary depending on overall non-functional requirements. It determines the request and interfaces with core systems, probably using a more tightly coupled interface. The request is then satisfied in the core systems.

There are three types of service providers 240 identified in the architectures illustrated: domain 242, integration 246 and enterprise 244 service providers. The domain service providers 242 integrate with core systems in the enterprise responsible for providing core business functions. These systems are organized into “domains” or areas of function. For example a banking service provider might exist for a financial enterprise that provides banking functions, such as account management.

Enterprise service providers 244 integrate with other “non-core” systems that provide functions that are not directly related to core business functions. The distinction between core and enterprise service domains is made to address the potential differences in non-functional requirements. Examples of these services might provide access to enterprise calendaring or messaging functions. Of course, the embodiments herein are not limited to the business systems illustrated and can vary in any number of ways as contemplated by the scope of the appended claims.

A third type of provider is a key component in the overall architecture. The integration service provider 246 is the integration point that owns business processes that span disparate systems or service providers in an enterprise. In some respects, it is the “hub” in a service oriented architecture. One distinction between a traditional hub-oriented architecture and the architecture herein is that the hub looks to the channels as just another service. The integration Service Provider 220 is the integration point that owns business processes or business flow that spans disparate systems or service providers 240 in an enterprise.

The integration service provider 246 can reduce the complexities required for point-to-point integration and can provide additional integration features such as key correlation, message transformation, and automatic publish/subscribe functions. It can also operate as the system of record for service locations in the enterprise. The integration service provider 246 can works with the service gateway component 230 to provide access to the enterprise service architecture for client applications residing at the Branch. Second, the integration service provider 246 can function as a business process integration (BPI) service provider for services that span multiple applications or application domains (such as CRM, Core Banking Systems or other operational systems). A workflow that requires interactions across these domains is managed and owned by the integration service provider 246.

The service gateway 230 and integration service provider 246 components combine to offer channel clients 210 and applications the best method of accessing enterprise services. For “atomic” service requests that are discrete transactions, requiring only one service domain the gateway 230 can use direct binding to provide the quickest possible access to the service provider 240. For “compound” service requests that involve flows across multiple service domains, the gateway 230 can rely on the integration service provider 246 to execute the required steps. The two components combine to provide greater flexibility and scalability than relying strictly on a hub and spoke architectural approach.

The level of availability will depend on the desired implementation. Since the integration service provider 246 serves as both the system of record for services or service manager in the enterprise and a BPI hub, multiple instances of the hub may be clustered together to provide for redundancy. As a BPI hub, the integration service provider should also persist state information for business processes in case of an abnormal termination of the server and be able to recover and restore to the original state later. The integration service provider 246 can also have access to a service directory (140).

The integration service provider 246 can be a master directory of services for the enterprise further having access to the service directory (140) as described above. On the other hand, it is also the enterprise BPI hub that manages the business flows between multiple service providers 240. The integration service provider 246 can be designed to provide enough flexibility to support different types of integration implementation including point-to-point integration as well as hub-and-spoke integration. Moreover, it should also support standard-based interface (such as web services), or use of traditional API interface. A BPI engine may also query the service directory (140) for service provider information when needed.

In order to fully support the BPI functions for the integration service provider 246, a process engine such as WEBSPHERE CROSSWORLDS EXCHANGE SERVER (ICS) or WEBSPHERE APPLICATION SERVER PROCESS CHOREOGRAPHER can be used. The engine should support integration with SOAP endpoints via multiple protocols like HTTP, HTTPS, or MQ. The services directory 140 can be implemented as an external repository using a relational data store or a UDDI directory.

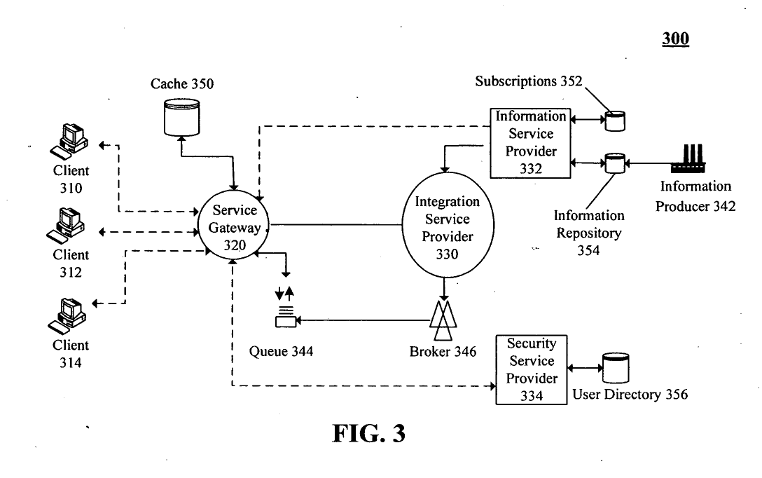

FIG. 3 is a schematic diagram of a system 300 where clients interact with a service gateway using a polling methodology and where the service gateway interacts with service providers using a subscription methodology in accordance with an embodiment of the inventive arrangements disclosed herein. System 300 can utilize components detailed in systems 100 and/or 200.

System 300 resembles a polling architecture from the perspective of clients 310-314. That is, clients 310-314 pull information from service providers through service gateway 320. For example, client 310 can make an initial service request to information service provider 332. The service request can specify a desired data context.

The service request is conveyed to service gateway 320. Service gateway 320 can break down the service request into component parts. The cache 350 can be searched for unexpired values that satisfy the service request, or component parts thereof. If found, a response can be generated from information in cache 350 and returned to client 310. Otherwise, gateway 320 can forward the request to a service provider 330, 332, and/or 334.

Gateway 320 can obtain a service endpoint from the cache 350 to determine provider locations. If a provider location is not found, the gateway 320 can request the required endpoint form the integration service provider 334. The service gateway 320 can generate a service request to obtain user identity information for client 310. This service request can be submitted to security service provider 334. The security service provider 334 can map a client's user context in the original SOAP request to a context valid for the information service provider 332. This mapping information can be conveyed back to service gateway 320.

Gateway 320 can add non-functional information including the user context to a new service request along with an information request that is sent to the information service provider 332. The information service provider 332 can create or update a data subscription in subscription data store 352 for client 310 and can generate a response containing the requested data. The response can be conveyed from the information service provider 332 to the service gateway 320. The service gateway 320 can forward the response to client 310.

System 300 can represent a subscription based architecture from the perspective of an information producer 342 or an information service provider 332. That is, information producers 342 push data updates to the service gateway 320, which updates information stored in cache 350. More specifically, data values, from the information provider 342 can be placed in information repository 354 through a periodic data collection process of the information provider 342. The information service provider 332 can be notified of the update through an asynchronous process.

The information service provider 332 can poll subscriptions in the subscription data store 352 to determine clients 312 affected by the data update. The information service provider 332 can generate new data responses for each affected subscription. The new responses can be pushed to the integration service provider 330 or pushed directly to the service gateway 320 (if the service is atomic as discussed in system 200).

The integration service provider 330 can publish pregenerated values to each publication sub-topic in the subscription to which the data update relates. The sub-topics can be based on the client source and which of many possible gateways 320 is most appropriate to cache the information. Typically, the publication will occur to the gateway 320 which initially received a service request. This can be the same gateway 320 that initially breaks down the service request into sub-topics. Publication can occur to publication/subscriber broker 346.

The publication/subscriber broker 346 can convey the sub-topic information to one or more subscription queues 344. Service gateway 320 can receive the publication via its subscription queue 344. The service gateway 344 can aggregate published data to produce appropriate updates to cache 350 elements. The updated cache 350 elements can be related to particular subscribed data contexts and/or alert contexts.

Client 310 can subsequently request data which is satisfied via a cache hit due to the proactive data push. One or more of clients 312-314 can also request data relating to an existing data context initially established by client 310. The requested data can be sent to the service gateway 320 as a service request.

It should be appreciated from system 300 that the major value propositions inherent in a SOA are preserved by maintaining a loosely coupled interaction between clients 310-314 and the service bus. The clients 310-314 can access an information stream without the scalability or latency issues that would typically arise for a strictly client-driven polling approach. The architecture of system 300 also provides for asynchronous client updates by pushing information closest to the consumers without requiring a point-to-point solution, which loses the advantages of a loosely coupled solution.

The present invention may be realized in hardware, software, or a combination of hardware and software. The present invention may be realized in a centralized fashion in one computer system, or in a distributed fashion where different elements are spread across several interconnected computer systems. Any kind of computer system or other apparatus adapted for carrying out the methods described herein is suited. A typical combination of hardware and software may be a general purpose computer system with a computer program that, when being loaded and executed, controls the computer system such that it carries out the methods described herein.

The present invention also may be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

This invention may be embodied in other forms without departing from the spirit or essential attributes thereof. Accordingly, reference should be made to the following claims, rather than to the foregoing specification, as indicating the scope of the invention.

What is claimed is:

1. A service gateway comprising:
a client portal configured to receive service requests from clients and configured to responsively provide service responses to the received service requests, wherein the client portal exchanges information with the clients using a polling methodology; and
a provider portal configured to forward service requests to service providers and configured to responsively receive service responses for the service requests, wherein the provider portal exchanges information with service providers using a subscription methodology.

2. The service gateway of claim 1, further comprising
a dynamic runtime cache in which responses to service requests provided by service providers are stored, wherein the dynamic runtime cache is searched for responses for received service requests before those requests are forwarded to a service provider, wherein responses from the dynamic runtime cache that match incoming requests are directly provided to clients.

3. The service gateway of claim 2, wherein responses stored in the dynamic runtime cache are linked to subscriptions established between the service gateway and the service providers.

4. The service gateway of claim 3, wherein each of the subscriptions is initiated by a service request received from a client through the client portal.

5. The service gateway of claim 4, wherein the service provider pushes data updates relating to the subscriptions to the service gateway each data context associated with an active subscription to the service gateway, wherein the service provider is configured to automatically update responses linked to the descriptions in accordance with the data updates.

6. The service gateway of claim 1, wherein service requests and services responses are conveyed between clients and the service gateway and are conveyed between the service gateway and service providers conform to a SOAP based protocol.

7. The service gateway of claim 1, wherein the service providers provide Web services, wherein the service requests are requests for Web services.

8. A scalable method for responding to service requests using a service gateway comprising:
a service gateway receiving a plurality of service requests from a plurality of clients;
the service gateway placing answers to previous requests in a dynamic runtime cache;
for each new service request, searching the dynamic runtime cache for an answer to the service request;
when an answer is found in the cache, directly conveying the answer from the cache to a client;
when the answer is not found in the cache, forwarding the service request to a service provider;
the service gateway placing a answer for the service request received from the service provider in the dynamic runtime cache; and
conveying the answer to a client in response to the service request.

9. The method of claim 8, wherein each of the clients conveys service requests to the service gateway and receives service responses from the service gateway using a polling methodology.

10. The method of claim 9, wherein the service gateway conveys service requests to the service provider and receives services responses from the service provider using a subscription methodology.

11. The method of claim 10, further comprising:
the service provider pushing data updates for subscriptions to the service gateway; and
the service gateway updating answers associated with the subscriptions and stored in the dynamic runtime cache in accordance with the data updates.

12. The method of claim 9, wherein the service gateway is one of many service gateways that functions as a communication intermediary between clients and the service provider, wherein each service provider is a Web service provider and each service request is a request for a Web service.

13. The method of claim 8, wherein services requests conveyed from clients to the service gateway and from the service gateway to the service provider using a SOAP based protocol, and wherein answers conveyed from the service provider to the service gateway and from the service gateway to the clients are provided within service responses and conveyed using a SOAP based protocol.

14. The method of claim 8, wherein said steps of claim 1 are performed by at least one machine in accordance with at least one computer program having a plurality of code sections that are executable by the at least one machine.

15. A service-oriented software system comprising:
at least one service provider comprising a plurality of service objects, each service object comprising a self-describing, self-contained, platform independent, modular unit of application logic; and
a service gateway comprising a dynamic runtime cache in which information generated in response to service requests is stored, wherein the service gateway is configured to exchange information with the service provider using a subscription based methodology, and wherein clients submit requests and receive information from the service gateway using a polling based methodology.

16. The system of claim 15, wherein that at least one service provider includes an integration service provider, wherein at least one of the plurality of service objects of the integration service provider functions as a hub through which a plurality of enterprise applications communicate with each other.

17. The system of claim 16, wherein at least one of the plurality of service objects expose functions of at least one said enterprise applications to a channel application.

18. The system of claim 17, wherein at least two different ones of said service objects expose functions of said enterprise applications to at least two channel applications, each of said at least two different service objects being associated with one of said at least two channel applications, and wherein said at least two channel applications correspond to different service channels.

19. The system of claim 17, wherein the service gateway is configured to convey requests from the channel application to said service provider and to convey responses from the service provider to the channel application, wherein the requests and responses are formatted in accordance with an open, standard protocol configured to exchange of information in a decentralized, distributed environment, and wherein the protocol is an extensible markup language (XML) based protocol.

20. The system of claim 17, further comprising
at least one client application for at least one of the clients, the at least one client application having a client interface through which a user of the client application is provided with access to the channel application, the client interface permitting the user to utilize the exposed functions.
